(19) United States
(12) Patent Application Publication
(10) Pub. No.: US 2012/0314197 A1
(43) Pub. Date: Dec. 13, 2012

(54) MASKLESS PROCESSING APPARATUS

(75) Inventor: Gi Lyong Na, Gyunggi-do (KR)

(73) Assignee: Samsung Electro-Mechanics Co., Ltd., Gyunggi-do (KR)

(21) Appl. No.: 13/251,918

(22) Filed: Oct. 3, 2011

(30) Foreign Application Priority Data
Jun. 8, 2011 (KR) 1020110055281

(51) Int. Cl. G03B 27/54

(52) U.S. Cl. 355/67

(57) ABSTRACT

Disclosed herein is a maskless processing apparatus including: an illumination optical system providing light illuminated to a substrate; a spatial light modulator (SLM) including a plurality of light conversion devices and controlling corresponding light conversion devices to selectively reflect or transmit the light illuminated from the illumination optical system according to a processing pattern, thereby converting a light amount; a projection optical system arranged so that the plurality of light conversion devices collect light corresponding to a single pixel of the substrate and projecting high energy light provided by the plurality of corresponding light conversion devices to a corresponding pixel when the light converted from the SLM is input; and a controller controlling the SLM to receive the processing pattern and selectively convert the light illuminated from a light source through the plurality of light conversion devices according to the received processing pattern. A digital mask is used, thereby reducing a use cost of a mask, easily taking active action against a change in scale of a product to be processed, and increasing the utilization of maskless processing apparatus.

### CROSS REFERENCE TO RELATED APPLICATION

This application claims the benefit of Korean Patent Application No. 10-2011-0055281, filed on Jun. 8, 2011, entitled “Maskless Processing Apparatus”, which is hereby incorporated by reference in its entirety into this application.

### BACKGROUND OF THE INVENTION

1. Technical Field

The present invention relates to a maskless processing apparatus.

2. Description of the Related Art

Generally, an exposure apparatus used in the industry world may be largely divided into an apparatus using a mask utilizing a film, a glass, a metal, and the like, and an apparatus using a digital mask utilizing a spatial light modulator (SLM).

Here, the exposure apparatus using the digital mask utilizing the SLM is an apparatus that forms patterns directly on a substrate formed of a film, a wafer, a glass, a polymer, or the like, using light without using a predetermined mask material (for example, a photomask).

Since this maskless exposure apparatus may form patterns on the substrate without using the photomask, a high resolution and large size mask needs not to be manufactured and replacement of the mask due to foreign materials and defects is not required. Therefore, a demand for the maskless exposure apparatus has increased.

In the maskless exposure apparatus, a digital micro mirror device (DMD) formed of a plurality of light conversion devices is mainly used as a digital mask.

However, in order to use the DMD as the digital mask, an optical energy input to the DMD needs to be used below the maximum optical energy of each DMD device so that the DMD may function without being damaged.

Due to this limitation, the maskless exposure apparatus using the DMD has generally been restrictively used only for use of exposure, and has not been used for a process requiring an energy much higher than an energy required in an exposure process.

### SUMMARY OF THE INVENTION

The present invention has been made in an effort to provide a maskless processing apparatus capable of providing a high energy to an object to be processed without causing damages of each of a plurality of light conversion devices used as a digital mask by collecting light from the plurality of light conversion devices and allow the collected light to correspond to a single pixel.

According to a preferred embodiment of the present invention, there is provided a maskless processing apparatus including: an illumination optical system providing light used as a processing energy of a substrate to thereby illuminate the light to the substrate; a spatial light modulator (SLM) including a plurality of light conversion devices and controlling corresponding light conversion devices to selectively reflect or transmit the light illuminated from the illumination optical system according to a processing pattern, thereby converting a light amount; a projection optical system arranged so that the plurality of light conversion devices collect light corresponding to a single pixel of the substrate and projecting high energy light provided by the plurality of corresponding light conversion devices to a corresponding pixel when the light converted from the SLM is input; and a controller controlling the SLM to receive the processing pattern and selectively convert the light illuminated from a light source through the plurality of light conversion devices according to the received processing pattern.

The illumination optical system may include: the light source providing the light used as the processing energy of the substrate; and a light source part converting the light input from the light source into light having a size and energy distribution capable of being illuminated to the SLM.

The light source may be a laser beam, and the light source part may be a plurality of optical lenses.

The SLM may be a reflective SLM in which micro mirrors are used as the plurality of light conversion devices and a light amount is controlled by controlling turn on/off and an angle of a corresponding micro mirror according to the processing pattern according to the processing pattern.

The reflective SLM may be a digital micro mirror device (DMD).

The SLM may be a transmissive SLM in which pixels are used as the plurality of light conversion devices and a light amount is controlled by controlling transmissivity of a corresponding pixel.

The transmissive SLM may be any one of a liquid crystal display (LCD) and a liquid crystal on silicon (LCoS).

The projection optical system may include a micro lens array (MLA) arranged to receive the light converted from the plurality of light conversion devices and collect the light corresponding to the single pixel of the substrate.

The projection optical system may further include a projective lens installed between the MLA and the substrate to thereby project the light collected by the MLA on the substrate.

The projective lens may be a projection lens.

### BRIEF DESCRIPTION OF THE DRAWINGS

FIG. 1 is a block diagram of a maskless processing apparatus according to a preferred embodiment of the present invention; and

FIG. 2 is a schematic perspective view of a digital mask apparatus shown in FIG. 1.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

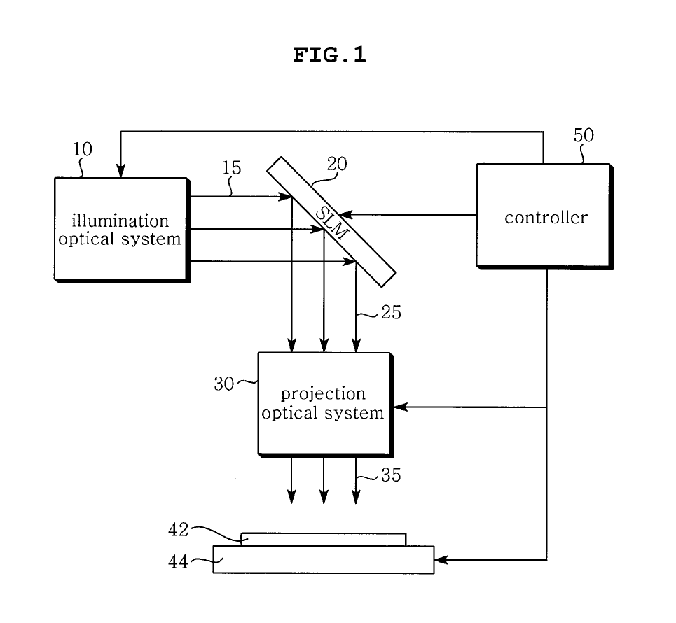

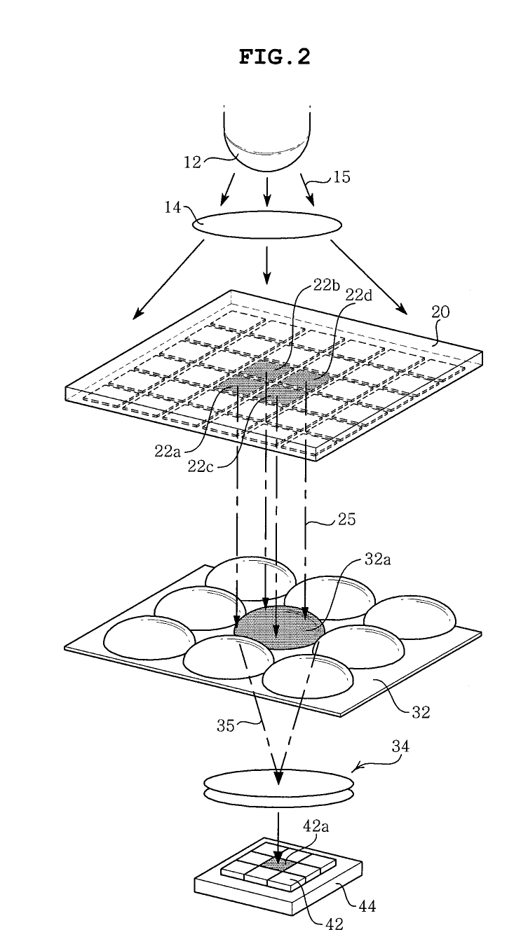

FIG. 1 is a block diagram of a maskless processing apparatus according to a preferred embodiment of the present invention; and FIG. 2 is a schematic perspective view of a digital mask apparatus shown in FIG. 1.

Referring to FIGS. 1 and 2, a maskless processing apparatus according to a preferred embodiment of the present invention is configured to include an illumination optical system 10, a spatial light modulator (SLM) 20, a projection optical system 30, a substrate 42, a stage 44, and a controller 50.

The illumination optical system 10 includes a light source 15 providing light 15 used as a processing energy of a substrate 42 to be processed to the substrate 42. The light source 12 provides the light for exposing or processing the substrate 42 so as to form a predetermined pattern in the substrate 42.

As the light source 12 providing the light 15 for exposing or processing the substrate 42, for example, a laser beam may be used.

The illumination optical system 10 further includes a predetermined light source part 14 capable of passing the light input from the light source 12 therethrough and converting the light into light having a size and energy distribution that may be illuminated to the SLM 20. The light source part 14 may be configured, for example, by arranging predetermined lenses.

The light 15 illuminated from the illumination optical system 10 is input to the SLM.

The SLM 20, which is an apparatus selectively reflecting or transmitting the light 15 input from the illumination optical system 10 according to an input processing pattern (for example, an exposure pattern), is configured by arranging a plurality of light conversion devices 22a to 22d in a matrix form.

Here, the SLM 20 may be a reflective SLM in which micro mirrors are used as the plurality of light conversion devices 22a to 22d.

The reflective SLM controls a light amount by controlling turn on/off and an angle of each micro mirror according to a position. As the reflective SLM, for example, a digital micro mirror device (DMD) is used.

In addition, the SLM 20 may be a transmissive SLM in which pixels are used as the plurality of light conversion devices 22a to 22d.

The transmissive SLM controls a light amount by controlling transmissivity of each of the plurality of pixels. As the transmissive SLM, for example, a liquid crystal display (LCD) or a liquid crystal on silicon (LCoS) is used.

The SLM 20 receives a processing pattern to be formed through the controller 50 and converts the received processing pattern into information corresponding to each pixel of the substrate 42 to control the corresponding light conversion devices 22a to 22d, thereby converting the light amount. The light 25 converted as described above is illuminated toward the substrate 42.

That is, the SLM 20 may previously receive a shape of a pattern appropriate for a specific area of the substrate 42 according to the processing pattern as an electrical signal and selectively reflect or transmit the light 15 illuminated from the light source 12 according to the electrical signal.

The light 25 converted from the SLM 20 is input to the projection optical system 30.

The projection optical system 30 improves quality of the light reflected from the SLM 20 and projects the light having the improved quality on the substrate.

The projection optical system 30 includes a micro lens array (MLA) 32 arranged so that the plurality of light conversion devices 22a to 22d collects the light corresponding to a single pixel 42a of the substrate 42.

The MLA 32 in which each lens element is a spherical surface or non-spherical surface lens having a circular or rectangular shape collects the light 25 converted from the SLM 20 according to the processing pattern on the substrate 42.

In other words, when the projection optical system 30 receives the light 25 converted from the SLM 20, it collects the light provided by the plurality of corresponding light conversion devices (for example, 22a to 22d) and projects the collected high energy light on the corresponding pixel (for example, 42a).

Unlike the exposure apparatus according to the prior art in which light is collected in one-to-one correspondence scheme between the plurality of light conversion devices and the pixels of the substrate 42, in the maskless processing apparatus according to the preferred embodiment of the present invention, a size and a magnification the MLA 32 is controlled so that the plurality of light conversion devices 22a to 22d correspond to the single pixel 42a of the substrate 40. Therefore, even though an optical energy less than the maximum optical energy of each of the light conversion devices 22a to 22d is used in order to prevent damages of each of the light conversion devices 22a to 22d, the light 35 provided to the single pixel 42a of the substrate 42 may have a high energy.

Therefore, the maskless processing apparatus according to the preferred embodiment of the present invention may also be used in an exposure process of the substrate 42 or a process requiring an energy higher than an energy required in the exposure process (for example, an etching process of a substrate according to a processing pattern), without causing damages of the corresponding light conversion devices 22a and 22d.

Meanwhile, the projection optical system 30 may further include a projective lens 34 installed between the MLA 32 collecting the light 52 converted from SLM 20 and the substrate 42.

When the MLA 32 is adjacent to an upper surface of the substrate 42, transmissivity of the light 35 may be lowered due to fumes generated in a pattern material.

Therefore, the projective lens 34 is installed between the MLA 32 and the substrate 42, thereby making it possible to project the light 35 collected by the MLA 32 as it is on the substrate 42.

As the projective lens 34, a projection lens may be used.

In addition, even though the MLA 32 is at a relatively long distance from the substrate 42 as compared to a case in which it is adjacent to the substrate 42, the projective lens 34 may allow the light 35 to be illuminated.

In addition, the projective lens 34 may have a predetermined magnification and select a precision and a range of a pattern to be processed according to the magnification.

The stage 44 is a place on which the substrate 42 is disposed, the substrate having he pattern to be processed therein. The stage 44 performs an exposure process or a predetermined process requiring energy higher than energy required in the exposure process according to the processing pattern while moving in a scan direction.

The controller 50 generally controls the maskless processing apparatus according to the preferred embodiment of the present invention. First, the controller 50 receives a processing pattern to be processed in the substrate 42 through a predetermined input device (not shown).

Then, the controller 50 performs a control to operate the illumination optical system 10 according to the input processing pattern to input the light 15 from the light source 12 to the SLM 20. In addition, the controller 50 performs a control to operate the SLM 20 to control the corresponding light conversion devices 22a to 22d, thereby converting the light amount.

Further, the controller 50 controls the projection optical system 30 to control a lens magnification or a pixel size so that the light 25 converted from the plurality of light conversion devices 22a to 22d of the SLM 20 is collected on any one (for example, 42a) of pixels on a predetermined position of the substrate 42.

Furthermore, the controller 50 controls the stage 44 having the substrate 42 disposed thereon to move in the scan direction so that the stage 44 performs the exposure process of the substrate 42 or the process requiring an energy higher than an energy required in the exposure process according to the input processing pattern.

As described above, since the plurality of light conversion devices 22a to 22d corresponding to the single pixel 42a of the substrate 42 through the use of the MLA 32, even though an optical energy less than a use limit light amount (the maximum optical energy) of the corresponding light conversion devices 22a to 22d is used, the highest energy may be provided to the substrate 42 to be processed.

As set forth above, the maskless processing apparatus including the digital mask using the SLM 20 is used, thereby reducing a use cost of a physical mask such as a photo mask and easily taking active action against a change in scale of a product to be processed. In addition, since the maskless processing apparatus provides a high energy to an object to be processed without causing a damage of the digital mask device, it may be used in various substrate processing processes requiring the high energy as well as the exposure process, such that the utilization thereof increases.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A maskless processing apparatus comprising:
an illumination optical system providing light used as a processing energy of a substrate to thereby illuminate the light to the substrate;
a spatial light modulator (SLM) including a plurality of light conversion devices and controlling corresponding light conversion devices to selectively reflect or transmit the light illuminated from the illumination optical system according to a processing pattern, thereby converting a light amount;
a projection optical system arranged so that the plurality of light conversion devices collect light corresponding to a single pixel of the substrate and projecting high energy light provided by the plurality of corresponding light conversion devices to a corresponding pixel when the light converted from the SLM is input; and
a controller controlling the SLM to receive the processing pattern and selectively convert the light illuminated from a light source through the plurality of light conversion devices according to the received processing pattern.

2. The maskless processing apparatus as set forth in claim 1, wherein the illumination optical system includes:
the light source providing the light used as the processing energy of the substrate; and
a light source part converting the light input from the light source into light having a size and energy distribution capable of being illuminated to the SLM.

3. The maskless processing apparatus as set forth in claim 2, wherein the light source is a laser beam.

4. The maskless processing apparatus as set forth in claim 2, wherein the light source part is a plurality of optical lenses.

5. The maskless processing apparatus as set forth in claim 1, wherein the SLM is a reflective SLM in which micro mirrors are used as the plurality of light conversion devices and a light amount is controlled by controlling turn on/off and an angle of a corresponding micro mirror according to the processing pattern.

6. The maskless processing apparatus as set forth in claim 5, wherein the reflective SLM is a digital micro mirror device (DMD).

7. The maskless processing apparatus as set forth in claim 1, wherein the SLM is a transmissive SLM in which pixels are used as the plurality of light conversion devices and a light amount is controlled by controlling transmissivity of a corresponding pixel according to the processing pattern.

8. The maskless processing apparatus as set forth in claim 7, wherein the transmissive SLM is any one of a liquid crystal display (LCD) and a liquid crystal on silicon (LCoS).

9. The maskless processing apparatus as set forth in claim 1, wherein the projection optical system includes a micro lens array (MLA) arranged to receive the light converted from the plurality of light conversion devices and collect the light corresponding to the single pixel of the substrate.

10. The maskless processing apparatus as set forth in claim 9, wherein the projection optical system further includes a projective lens installed between the MLA and the substrate to thereby project the light collected by the MLA on the substrate.

11. The maskless processing apparatus as set forth in claim 10, wherein the projective lens is a projection lens.
